(19) United States
(12) Patent Application Publication
(10) Pub. No.: US 2020/0372507 A1
(43) Pub. Date: Nov. 26, 2020

(54) IDENTIFICATION CODE PULLING METHOD, STORAGE MEDIUM, TERMINAL DEVICE, AND SERVER

(71) Applicant: Tencent Technology (Shenzhen) Company Limited, Shenzhen (CN)

(72) Inventor: Ruikai LIU, Shenzhen (CN)

(73) Assignee: Tencent Technology (Shenzhen) Company Limited, Shenzhen (CN)

(21) Appl. No.: 16/991,398

(22) Filed: Aug. 12, 2020

Related U.S. Application Data
(63) Continuation of application No. PCT/CN2019/081433, filed on Apr. 4, 2019.

(30) Foreign Application Priority Data
May 25, 2018 (CN) 201810512605.7

(51) Int. Cl. G06Q 20/40; G06Q 20/32

(52) U.S. Cl. CPC G06Q 20/409; G06Q 20/3276; G06Q 20/3274

(57) ABSTRACT

Embodiments of this application include an identification code pulling method, a storage medium, a terminal device, and a server, applied to the field of communications technologies. In the identification code pulling method, a user input corresponding to a request for an identification code is received. A device authorization message of an application client is obtained based on the user input corresponding to the request for the identification code. A pull request for the identification code is generated. The pull request includes a user identifier, device information, and the device authorization message of the application client. The pull request is transmitted to an application platform. Further, identification code information corresponding to the identification code is received from the application platform when the user identifier, the device information, and the device authorization message are verified by the application platform.

### RELATED APPLICATION

This application is a continuation of International Application No. PCT/CN2019/081433, filed on Apr. 4, 2019, which claims priority to Chinese Patent Application No. 201810512605.7, filed on May 25, 2018, and entitled “IDENTIFICATION CODE PULLING METHOD, STORAGE MEDIUM, TERMINAL DEVICE, AND SERVER.” The entire disclosures of the prior applications are hereby incorporated by reference in their entirety.

### FIELD OF THE TECHNOLOGY

This application relates to the field of communications technologies, including an identification code pulling method, a storage medium, a terminal device, and a server.

### BACKGROUND OF THE DISCLOSURE

With development of information technologies, there have been many methods for expressing information in a simple manner. For example, an identification code, such as a two-dimensional barcode or a barcode, is used for expressing information. Such a manner is simple and safe and is applied to many fields such as the field of payment. At present, many application clients have a function of pulling an identification code, such as a two-dimensional barcode, online, to present information of a user to another user.

### SUMMARY

Embodiments of this application provide an identification code pulling method, a storage medium, a terminal device, and a server, to obtain a corresponding identification code according to a device authorization message of an application client.

One aspect of the embodiments of this application provides an identification code pulling method. In the identification code pulling method, a user input corresponding to a request for an identification code is received. A device authorization message of an application client is obtained based on the user input corresponding to the request for the identification code. A pull request for the identification code is generated. The pull request includes a user identifier, device information, and the device authorization message of the application client. The pull request is transmitted to an application platform. Further, identification code information corresponding to the identification code is received from the application platform when the user identifier, the device information, and the device authorization message are verified by the application platform.

One aspect of the embodiments of this application provides an identification code pulling method. In the identification code pulling method, a pull request for an identification code is received from an application client. The pull request includes a device authorization message, a user identifier, and device information of the application client. Verification is performed on the device authorization message in the pull request when correspondences between the device authorization message, the device information, and the user identifier are stored in a memory. Identification code information corresponding to the identification code is obtained according to the pull request when the device authorization message in the pull request is verified. Further, the identification code information is transmitted to the application client.

One aspect of the embodiments of this application provides a terminal device, including processing circuitry. The processing circuitry is configured to receive a user input corresponding to a request for an identification code, and obtain a device authorization message of an application client run by the processing circuitry based on the user input corresponding to the request for the identification code. The processing circuitry is configured generate a pull request for the identification code. The pull request includes a user identifier, device information, and the device authorization message of the application client. Further, the processing circuitry is configured to transmit the pull request to an application platform, and receive identification code information corresponding to the identification code from the application platform when the user identifier, the device information, and the device authorization message are verified by the application platform.

One aspect of the embodiments of this application provides a server, including processing circuitry. The processing circuitry is configured to receive a pull request for an identification code from an application client. The pull request includes a device authorization message, a user identifier, and device information of the application client. The processing circuitry is configured to perform verification on the device authorization message in the pull request when correspondences between the device authorization message, the device information, and the user identifier are stored in a memory. The processing circuitry is configured to obtain identification code information corresponding to the identification code according to the pull request when the device authorization message in the pull request is verified. Further, the processing circuitry is configured to transmit the identification code information to the application client.

One aspect of the embodiments of this application provides non-transitory computer-readable storage mediums storing instructions which when executed by a processor cause the processor to perform any of the identification code pulling methods according to the embodiments of this application.

One aspect of the embodiments of this application provides a terminal device, including a processor and a storage medium, the processor being configured to implement each instruction. The storage medium is configured to store a plurality of instructions, the instructions being loaded by the processor to perform the identification code pulling method according to the embodiments of this application.

One aspect of the embodiments of this application provides a server, including a processor and a storage medium, the processor being configured to implement each instruction. The storage medium is configured to store a plurality of instructions, the instructions being loaded by the processor to perform the identification code pulling method according to the embodiments of this application.

### BRIEF DESCRIPTION OF THE DRAWINGS

To describe the technical solutions of the embodiments of this application more clearly, the following briefly describes the accompanying drawings for describing the embodiments. The accompanying drawings in the following description show only some embodiments of this application, and a person of ordinary skill in the art may still derive other drawings from the accompanying drawings.

FIG. 1 is a schematic structural diagram of a system to which an identification code pulling method is applied according to an embodiment of this application.

FIG. 2 is a flowchart of an identification code pulling method according to an embodiment of this application.

FIG. 3 is a flowchart of an identification code pulling method according to an embodiment of this application.

FIG. 4 is a schematic diagram of an application platform performing verification on a received authorization request according to an embodiment of this application.

FIG. 5 is a schematic structural diagram of a WeChat platform according to an embodiment of this application.

FIG. 6 is a flowchart of a two-dimensional barcode pulling method according to an embodiment of this application.

FIG. 7 is a flowchart of an authorization method of a digital certificate according to an embodiment of this application.

FIG. 8A is a schematic structural diagram of an application client according to an embodiment of this application.

FIG. 8B is a schematic structural diagram of an application client according to an embodiment of this application.

FIG. 9A is a schematic structural diagram of an application platform according to an embodiment of this application.

FIG. 9B is a schematic structural diagram of an application platform according to an embodiment of this application.

FIG. 10 is a schematic structural diagram of a terminal device according to an embodiment of this application.

### DESCRIPTION OF EMBODIMENTS

The following describes technical solutions in the embodiments of this application with reference to the accompanying drawings in the embodiments of this application. The described embodiments are merely some embodiments of this application rather than all of the embodiments. All other embodiments obtained by a person of ordinary skill in the art based on the embodiments of this application shall fall within the protection scope of this application.

In the specification, claims, and accompanying drawings of this application, the terms “first”, “second”, “third”, “fourth”, and so on (if existing) are intended to distinguish between similar objects rather than describe a specific order or sequence. It may be understood that the data termed in such a way is interchangeable in proper circumstances, so that the embodiments of this application described herein for example, can be implemented in other orders than the order illustrated or described herein. Moreover, the terms “include”, “comprise” and any other variations mean to cover the non-exclusive inclusion. For example, a process, method, system, product, or device that includes a list of operations or units is not necessarily limited to those expressly listed steps or units, but may include other steps or units not expressly listed or inherent to such a process, method, system, product, or device.

According to an embodiment of this application, after a user logs in to an application platform through an application client with a user identifier, if the user initiates a two-dimensional barcode pulling process through the application client, the application platform determines whether or not to return a corresponding two-dimensional barcode to the application client according to the user identifier of the application client. However, the application platform cannot identify whether the user identifier of the application client is a user identifier stolen by others. As a result, if a user identifier of a specific user is stolen by another person, when the person logs in to the application platform through the application client with the user identifier, the application client pulling a two-dimensional barcode may cause a risk of user information leakage, and in particular, during payment with the two-dimensional barcode, a property loss of a user may be caused.

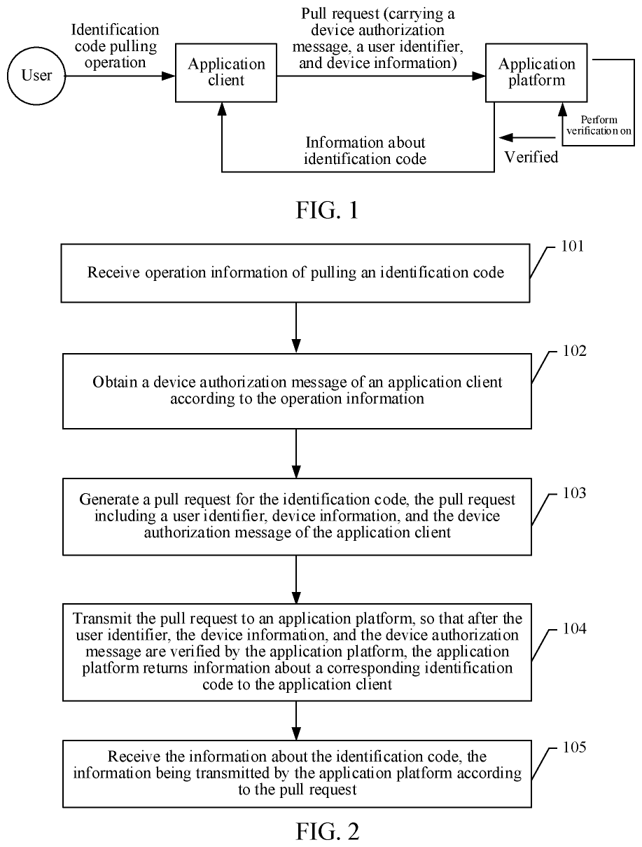

In view of the above, an embodiment of this application provides an identification code pulling method, which is applicable to a system as shown in FIG. 1 for example. The system includes an application client and an application platform. A user may pull an identification code from the application platform through any application client. During the process, the application client may implement identification code pulling through the following method.

The method can include receiving operation information of pulling an identification code; obtain a device authorization message of an application client according to the operation information; generating a pull request for the identification code, the pull request including a user identifier, device information, and the device authorization message of the application client; transmitting the pull request to an application platform, so that after the user identifier, the device information, and the device authorization message are verified by the application platform, the application platform returns information about a corresponding identification code to the application client; and receiving the information about the identification code, the information being transmitted by the application platform according to the pull request.

The application platform may implement identification code pulling through the following method: receiving a pull request for an identification code transmitted by application client, the pull request including a device authorization message, device information, and a user identifier of the application client; performing verification on the device authorization message in the pull request in a case that a storage of the application platform includes correspondences between the device authorization message, the device information, and the user identifier; and obtaining, in a case that the device authorization message in the pull request is verified, information about a corresponding identification code according to the pull request, and transmitting the information about the identification code to the application client.

The foregoing application client and application platform may be based on any application provided that the application client is equipped with a function of proactively pulling an identification code, for example, a WeChat client.

Because the device authorization message obtained by the application client requires network authorization, an identity corresponding to the application client may be represented. In this way, information about a corresponding identification code can be obtained only when a pull request for an identification code is initiated by the application client that is authorized with the device authorization message, and the device authorization message, device information, and a user identifier of the application client are verified. Therefore, security of proactively obtaining an identification code by an application client is improved.

An embodiment of this application provides an identification code pulling method, which may be performed by any computing device, for example, a terminal device, on which an application client is located. A flowchart of the method, as shown in FIG. 2, includes the following steps.

In step 101, operation information of pulling an identification code is received.

It may be understood that a user may operate an application client to enable the application client to log in to an application platform with a specific user identifier, so that the user may continue operating the application client to initiate an identification code pulling process. An identification code refers to, for example, a two-dimensional barcode or a barcode indicating a specific amount of information. The identification code pulled in this embodiment can be used to represent user information corresponding to the user identifier of the application client.

For example, if the application client is a WeChat client, the user may trigger a “Money” function in the WeChat client, so that the WeChat client proactively pulls a two-dimensional barcode from a WeChat platform to indicate information about “Money” of the user.

In step 102, a device authorization message of the application client is obtained according to the operation information.

The device authorization message refers to information about the application client after being authorized, and may be specifically a digital certificate. The digital certificate is a digital signature file for information about a device public key, information about an owner of the device public key, and other data. The digital signature file is used for marking identity information of a communication party. In this embodiment, the device authorization message is used for marking identity information of the application client. In addition, the device authorization message requires network authorization, and in this embodiment, the device authorization message needs to be authorized by the application platform or a third-party authorization center.

For example, when the device authorization message is obtained, whether a storage of the application client includes the device authorization message of the application client is determined first. If the device authorization message is included, the device authorization message is directly extracted from the storage of the application client. If the device authorization message is not included, the device authorization message may be obtained in the following two manners:

(1) A verification information inputting process is initiated first, and then, an authorization request for the device authorization message is initiated.

The application client directly displays a verification information input interface, the input interface including a verification information input box. The user may input verification information through the input box. The verification information is information that needs to be provided by the user for verification on the authorization request. In an actual application, the information may be a payment password, another password related to the user, or the like. In addition, the verification information may be different from a password provided by the user when the application client logs in to the application platform with the user identifier.

When receiving, through the input box, the verification information inputted by the user, the application client transmits the authorization request for the device authorization message to the application platform. The authorization request includes device information of the application client, the foregoing verification information inputted by the user, and the like for requesting the application platform to authorize the application client with the corresponding device authorization message. The authorization request may further include information, such as a user identifier and a public key, of the application client. In this way, the application platform performs verification on the verification information inputted by the user. If the verification information is verified, the application platform generates, according to the device information in the foregoing authorization request, a device authorization message, returns the device authorization message to the application client, and stores correspondences between the user identifier, the device authorization message, and the device information in the application platform. If the verification information fails to be verified, the application platform transmits a user prompt, to inform the user of the verification failure.

When receiving the device authorization message returned by the application platform, the application client places the device authorization message into the storage of the application client.

In this case, the application client proactively initiates verification on the authorization request.

(2) An authorization request for the device authorization message is initiated first, and then, a verification process is initiated.

The application client may first transmit the authorization request for the device authorization message to the application platform, the authorization request including device information of the application client, for requesting the application platform to authorize the application client with the corresponding device authorization message. The authorization request may further include information, such as a public key and a user identifier, of the application client. When receiving the authorization request, the application platform first performs a risk assessment on the user of the application client and/or the application client. If there is a risk, the application platform transmits a verification command to the application client, the verification command being used for requiring the user to provide verification information for verification on the authorization request. If there is no risk or the risk is low (e.g., below a threshold), the application platform directly generates a corresponding device authorization message according to the authorization request.

When receiving the verification command returned by the application platform according to the authorization request, the application client displays a verification information input interface, the input interface including a verification information input box, so that the user may input verification information through the input box.

When receiving, through the input box, the verification information inputted by the user, the application client transmits the verification information inputted by the user to the application platform for verification. If the verification information is verified, the application platform generates, according to the device information in the foregoing authorization request, a device authorization message corresponding to the application client, and returns the device authorization message to the application client, and stores correspondences between the user identifier, the device authorization message, and the device information in the application platform. If the verification information fails to be verified, the application platform informs the user of the verification failure.

When receiving the device authorization message returned by the application platform, the application client places the device authorization message into the storage of the application client.

In this case, the application platform proactively initiates verification on the authorization request.

In step 103, a pull request for an identification code is generated. The pull request includes a user identifier, device information, and a device authorization message of the application client. The pull request is used for requesting an identification code of some information, such as user payment information

In step 104, the pull request is transmitted to an application platform, so that after the device authorization message, the device information, and the user identifier are verified by the application platform, the application platform returns information about a corresponding identification code to the application client.

For example, when performing verification on the device authorization message, the device information, and the user identifier, the application platform mainly checks whether correspondences between the device authorization message, the device information, and the user identifier are currently stored in the application platform. If yes, the application platform may further perform other verification, for example, to perform verification on whether the device authorization message in the pull request is in a validity period. If not, the verification fails.

In step 105, the information about the identification code is received. The information about the identification code is transmitted according to the pull request, by the application platform, so that the application client may generate an identification code according to the information about the identification code.

The information about the identification code needs to be consistent with the received operation information in the foregoing step 101. That is, if the operation information of pulling the identification code is about a specific function, the information about the identification code is also user information based on the function.

For example, in the foregoing step 101, if the user operates the “Money” function in the WeChat client, a two-dimensional barcode returned by the WeChat platform is mainly used for indicating information about “Money” of the user, for example, information about a bound bank card.

Further, the application platform performs a risk assessment on the user identifier of the application client according to a specific period. If the user corresponding to the user identifier is risky, the application platform may transmit a device authorization message deletion command to the application terminal. After receiving the device authorization message deletion command transmitted by the application platform, the application client deletes the device authorization message stored in the application client.

In view of the above, according to the method in this embodiment, the application client may obtain the device authorization message of the application client according to the operation information of pulling the identification code by the user, adds the device authorization message and a user identifier and device information of the application client to the pull request, and transmits the pull request to the application platform, so that the application platform returns the corresponding information about the identification code to the application client only after the device authorization message, the device information, and the user identifier in the pull request are verified. Because the device authorization message obtained by the application client requires network authorization, an identity corresponding to the application client may be represented. In this way, information about a corresponding identification code can be obtained only when a pull request for an identification code is initiated by the application client that is authorized with the device authorization message, and the device authorization message, device information, and a user identifier of the application client are verified. Therefore, security of proactively obtaining an identification code by an application client is improved.

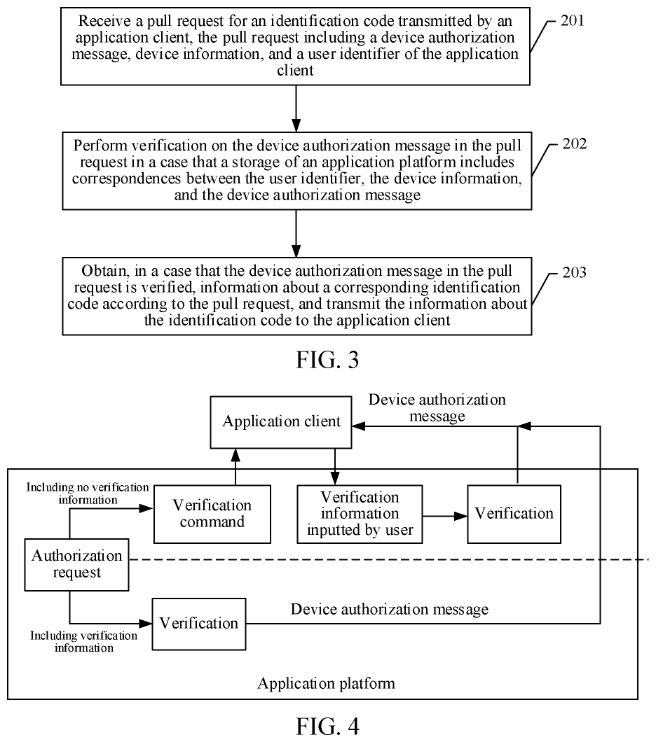

This application further provides an identification code pulling method, performed by a computing device on which an application platform is located. A flowchart of the method, as shown in FIG. 3, includes the following steps.

In step 201, a pull request for an identification code transmitted by an application client is received. The pull request includes a device authorization message, device information, and a user identifier of the application client.

It may be understood that a user may operate the application client to enable the application client to log in to an application platform with a user identifier, so that subsequent pull requests initiated by the user through the application client all include the user identifier. Moreover, in this embodiment of this application, the pull request also needs to include the device authorization message for authorizing the application client. In addition, the pull request may further include the device information, the user identifier, and the like of the application client, and may further include a public key and the like of the application client.

In step 202, verification on the device authorization message in the pull request is performed in a case that a storage of the application platform includes correspondences between the user identifier, the device information, and the device authorization message.

After receiving the pull request, the application platform performs a search to determine whether correspondences between the user identifier, the device information, and the device authorization message in the pull request are stored locally. If not, the pull request is rejected. If yes, the application platform needs to continue to perform verification on the device authorization message. If the device authorization message is a digital certificate, details are provided below.

The digital certificate of the application client in the pull request is a file for adding a digital signature to some information. Specifically, the digital certificate may be a file obtained after the application platform signs the information with a private key of the application platform before a pulling process. Therefore, when performing verification on the digital certificate in the pull request, the application platform may first obtain pieces of information included in the digital certificate according to the private key of the application platform, and then perform verification on the pieces of information one by one.

The pieces of information included in the digital certificate may include, but are not limited to, the following: a validity period of the certificate, a certificate number, and device information, and may further include a public key or the like. In this way, the application platform may verify whether the certificate number in the digital certificate is consistent with a certificate number stored in the application platform and whether the certificate number in the digital certificate is consistent with a certificate number of a digital certificate corresponding to the foregoing device information and the user identifier, verify whether the device information in the digital certificate is consistent with device information correspondingly stored in the application platform, verify whether the digital certificate exceeds the validity period, and verify whether the public key is consistent with a public key of the application client correspondingly stored in the application platform. If any of the pieces of information fails to be verified, for example, the digital certificate exceeds the validity period, or the certificate numbers are inconsistent, the device authorization message in the pull request fails to be verified. Only when all the pieces of information included in the digital certificate are verified, the device authorization message in the pull request is verified.

In step 203, in a case that the device authorization message in the pull request is verified, information about a corresponding identification code is obtained according to the pull request, and the information about the identification code is transmitted to the application client.

Further, if the device authorization message in step 202 fails to be verified, the pull request is directly rejected.

In view of the above, according to the method in this embodiment, the pull request for the identification code transmitted to the application platform by the application client, includes the device authorization message, the device information, and the user identifier of the application client. If the storage of the application platform includes correspondences between the user identifier, the device information, and the device authorization message, the application platform performs verification on the device authorization message in the pull request. Only if the verification succeeds, the application platform returns the corresponding information about the identification code to the application client. Because the device authorization message obtained by the application client requires network authorization, an identity corresponding to the application client may be represented. In this way, information about a corresponding identification code can be obtained only when a pull request for an identification code is initiated by the application client that is authorized with the device authorization message, and the device authorization message, device information, and a user identifier of the application client are verified. Therefore, security of proactively obtaining an identification code by an application client is improved.

In a specific embodiment, before the application platform performs the foregoing step 201, the application client may be authorized with the device authorization message. Specifically, the application platform receives an authorization request for the device authorization message transmitted by the application client, and then the processing may be performed in the following two manners:

(1) The application platform proactively initiates verification on the authorization request, of which a schematic diagram is shown as branches in the upper half separated by a dashed line in FIG. 4, including the following:

If the authorization request received by the application platform includes the user identifier and the device information of the application client, the authorization request may further include information, such as the public key, of the application client, and the application platform may directly transmit a verification command to the application client; or the application platform may first perform a risk assessment on the user of the application client and/or the application client. Only if there is a risk, the application platform transmits a verification command to the application client. The application client then displays a verification information input interface according to the verification command. The input interface includes a verification information input box, and the user may input verification information through the input box. When receiving, through the input box, the verification information inputted by the user, the application client transmits the verification information inputted by the user to the application platform.

The application platform receives the verification information that is inputted by the user and that is transmitted by the application client according to the verification command and performs verification on the verification information inputted by the user. For example, the application platform may verify whether verification information that is stored in the application platform and that corresponds to the user identifier is consistent with the verification information inputted by the user. If yes, the verification succeeds. Otherwise, the verification fails.

If the verification information inputted by the user is verified by the application platform, the application platform generates a device authorization message according to the device information, and transmits the generated device authorization message to the application client. In addition, the application platform may further store correspondences between the user identifier, the device authorization message, and the device information.

When generating the device authorization message, the application platform may first obtain a number of the device authorization message, a validity period, and device information of the application client, and may further obtain information, such as the public key, of the application client, and add a digital signature to the pieces of information with the private key of the application platform, where an obtained digital signature file such as a digital certificate, is the device authorization message.

(2) The application client proactively initiates verification on the authorization request, of which a schematic diagram is shown as branches in the lower half separated by the dashed line in FIG. 4, including the following:

If an authorization request received by the application platform includes verification information inputted by a user, and the user identifier and the device information of the application client, the application platform may directly perform verification on the verification information inputted by the user.

If the verification information inputted by the user is verified by the application platform, the application platform generates a device authorization message according to the device information, and transmits the generated device authorization message to the application client. The application platform may further store correspondences between the user identifier, the device authorization message, and the device information.

After receiving the authorization request for the device authorization message, the application platform may first check correctness of the authorization request, and specifically, may check correctness of a format and content of the authorization request. If the format of the authorization request is consistent with a preset format, and the content of the authorization request is consistent with the corresponding content stored in the application platform, the correctness of the authorization request is verified. After the authorization request is verified by the application platform, the application platform provides a generated device authorization message for the application client.

Further, after receiving the authorization request, the application platform may further perform a risk assessment on the application client and/or the user corresponding to the application client, to obtain a corresponding risk assessment score. If the risk assessment score is less than or equal to a specific threshold, the user of the application client and/or the application client pass or passes the risk assessment, and after the authorization request is verified by the application platform, the application platform may provide the generated device authorization message for the application client. If the risk assessment score is greater than the threshold, the user of the application client and/or the application client does not pass the risk assessment, and the application platform informs the application client and the user thereof

When obtaining the risk assessment score of the application client and/or the corresponding user of the application client, the application platform may obtain first information about a plurality of dimensions related to the application client, and/or obtain second information about a plurality of dimensions related to the user identifier corresponding to the application client. Then, the application platform may set a specific first subscore according to the first information about the plurality of dimensions, and/or set a specific second subscore according to the second information about the plurality of dimensions. Finally, the application platform may use a calculated value by a function between the first subscore and/or the second subscore as a final risk assessment score.

The first information about the plurality of dimensions may include operation information related to the application client, and the second information about the plurality of dimensions may include operation information related to the foregoing user identifier, for example, transaction information.

The correctness check on the authorization request and the risk assessment on the application client and/or the user corresponding to the application client further ensure security of authorizing the application client with a device authorization message.

Further, before the application platform stores correspondences between the user identifier, the device authorization message, and the device information, if the storage of the application platform includes an existing device authorization message corresponding to the user identifier, the application platform sets the existing device authorization message into an invalid state, or deletes the existing device authorization message. In this way, it is ensured that a user identifier and device information in an application platform correspond to only one piece of a device authorization message.

In another specific embodiment, the application platform determines a risk assessment score corresponding to the user identifier of the application client according to a preset period. If the risk assessment score is greater than a preset value, the application platform transmits a device authorization message deletion command to the application client, to delete the device authorization message stored in the application client. In this way, real-time interception is performed to reduce a loss of a user.

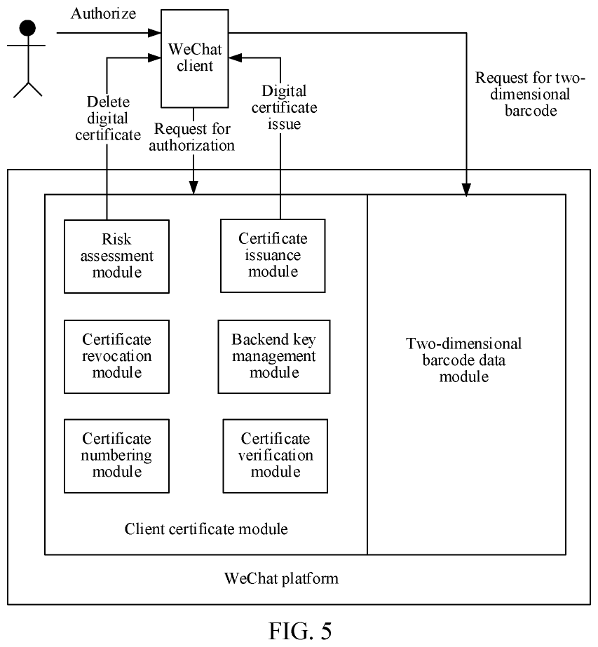

The following explains the method of this application by using a specific application embodiment. In this embodiment, the identification code is specifically a two-dimensional barcode, the pull request for the identification code is a pull request for the two-dimensional barcode, the device authorization message is a digital certificate, and the application client and the application platform are a WeChat client and a WeChat platform respectively. Referring to FIG. 5, in this embodiment, a WeChat platform may include a client certificate module and a two-dimensional barcode data module. One or more modules of the WeChat platform can be implemented by processing circuitry.

The client certificate module is mainly configured to process an operation related to a digital certificate, specifically including the following structures: a certificate numbering module, a certificate verification module, a backend key management module, a certificate revocation module, a certificate issuance module, a risk assessment module, and a two-dimensional barcode data module.

The certificate numbering module is configured to generate a unique number for each digital certificate. The certificate verification module is configured to perform verification on a digital certificate in a pull request for a two-dimensional barcode. The backend key management module is configured to store and manage all keys of the WeChat platform in an encrypted manner. Further, the certificate revocation module is configured to revoke, when a certificate issuance module generates a new digital certificate for a WeChat client corresponding to a user identifier, an originally stored digital certificate, that is, set the originally stored digital certificate into an invalid state.

The certificate issuance module is configured to check correctness of an authorization request for the digital certificate initiated by the WeChat client, generate a corresponding digital certificate for the authorization request that passes the check, and transmit the digital certificate to the WeChat client. The risk assessment module is configured to perform a risk assessment on the WeChat client and the user of the WeChat client, that is, determine a corresponding risk assessment score, and transmit a digital certificate deletion command to the WeChat client if the risk assessment score is greater than a preset value. Further, the two-dimensional barcode data module is configured to generate a corresponding two-dimensional barcode according to the pull request for the two-dimensional barcode of the WeChat client, and transmit the generated two-dimensional barcode to the WeChat terminal.

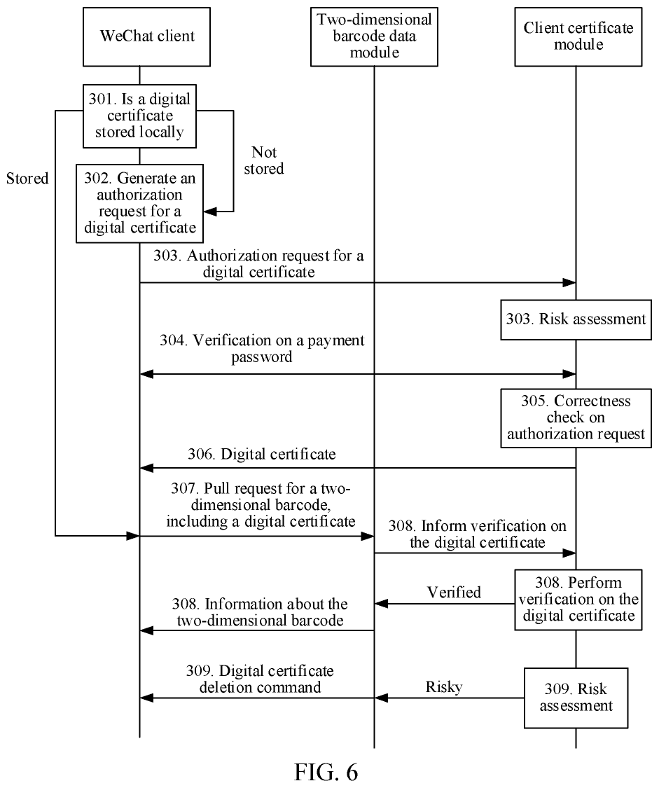

Referring to FIG. 6, a two-dimensional barcode pulling method in this embodiment may include the following steps.

In step 301, a user operates a WeChat client, to enable the WeChat client to log in to the WeChat platform with a user identifier 1. The user continues operating the WeChat client, and triggers a “Money” function in the WeChat client. Then, the WeChat client performs a search to determine whether a digital certificate of the WeChat client is stored locally. If yes, the WeChat client extracts the digital certificate directly, and performs step 307. If not, the WeChat client performs steps 302 to 306.

In step 302, the WeChat client obtains information, such as the user identifier 1, device information, and a public key of the WeChat client, and generates an authorization request of the WeChat client, the authorization request including the information, such as the user identifier 1, the device information, and the public key, of the WeChat client.

In step 303, the WeChat client transmits the generated authorization request to the WeChat platform. The risk assessment module in the WeChat platform performs a risk assessment on the WeChat client and the user identifier of the WeChat client, to obtain a corresponding risk assessment score. If the risk assessment score is greater than a specific threshold, step 304 is performed. If the risk assessment score is less than or equal to the threshold, the certificate verification module and certificate issuance module in the WeChat platform are informed to perform step 305.

In step 304, the certificate issuance module transmits a verification command to the WeChat client. The WeChat client directly displays a payment password input interface, such as verification information input interface, according to the verification command. The user inputs a payment password on the payment password input interface. When receiving, from the input interface, the payment password inputted by the user, the WeChat client transmits the payment password inputted by the user to the WeChat platform.

The certificate issuance module in the WeChat platform performs verification on the payment password inputted by the user. For example, the certificate issuance module verifies whether the payment password inputted by the user is consistent with a payment password that corresponds to the user identifier 1 and that is stored in the WeChat platform. If yes, the verification succeeds, step 305 is performed. If not, the user may be informed that the authorization request fails to be verified.

In step 305, the certificate issuance module checks correctness of the authorization request. If the authorization request is verified, that is, both a format and content of the authorization request are correct, the user identifier 1 in the authorization request is extracted, to determine whether the user corresponding to the user identifier 1 activates a digital certificate service. If yes, step 306 is performed. If not, the process is ended.

In step 306, the certificate issuance module extracts the device information of the WeChat client in the authorization request, and sets a validity period, a valid-from date, and a valid-to date of the digital certificate; the certificate issuance module invokes the certificate numbering module to generate a unique number of the digital certificate and invokes the key management module to obtain a private key of the WeChat platform.

Then, the certificate issuance module uses the private key of the WeChat platform to sign some information above, to obtain a signature file, that is, the digital certificate. In addition, the certificate issuance module stores correspondences between the digital certificate, the user identifier 1, and the public key and device information of the WeChat client, and transmits the generated digital certificate to the WeChat client.

After receiving the digital certificate returned by the WeChat platform, the WeChat client performs step 307.

In step 307, the WeChat client generates a pull request for a two-dimensional barcode and transmits the pull request for the two-dimensional barcode to the two-dimensional barcode data module of the WeChat platform. The pull request for the two-dimensional barcode includes information such as the digital certificate, and the user identifier 1 and device information of the WeChat client.

In step 308, the two-dimensional barcode data module in the WeChat platform determines correspondences between the foregoing user identifier 1, device information, and digital certificate, which is stored in the WeChat platform, and informs the certificate verification module to perform verification on the digital certificate in the pull request for the two-dimensional barcode. If the pull request is verified, the two-dimensional barcode data module is informed to obtain information about the two-dimensional barcode, which is specifically payment information of the user corresponding to the user identifier 1. Then, the two-dimensional barcode data module transmits the obtained information about the two-dimensional barcode to the WeChat client.

Instep 309, the risk assessment module in the WeChat platform determines the risk assessment score corresponding to the user identifier 1 of the WeChat client according to a preset period, and if the risk assessment score is greater than a specific preset value, transmits a digital certificate deletion command to the WeChat client, to delete the digital certificate stored in the WeChat client. In this way, real-time interception is performed to reduce a loss of a user.

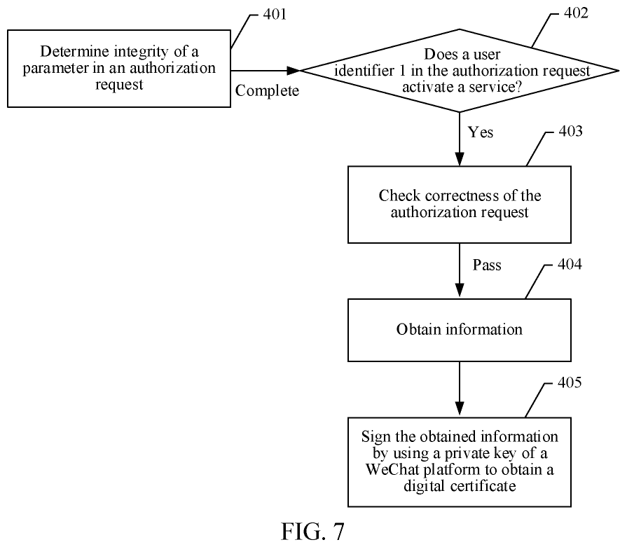

A process in which the WeChat platform authorizes a WeChat client with a digital certificate may generally be implemented in the following process, as shown in FIG. 7, including the following steps.

In step 401, after the WeChat platform receives an authorization request for a digital certificate, the certificate issuance module may first determine integrity of a parameter in the authorization request. If the parameter in the authorization request is complete, step 402 is performed. If the parameter is incomplete, the authorization request is rejected.

The determination, by the certificate issuance module, integrity of a parameter in the authorization request includes determining whether the authorization request includes a plurality of pieces of required information, for example, the user identifier 1, the device information, and information, such as the public key, of the WeChat client. If any piece of information is lost, the authorization request is incomplete.

In step 402, the certificate issuance module extracts a user identifier 1 from the authorization request, and determines whether a user corresponding to the user identifier 1 activates a digital certificate service. If yes, step 403 is performed. If not, the authorization request is rejected.

In step 403, the certificate issuance module checks correctness of the authorization request. If the authorization request passes the check, step 404 is performed. If the authorization request does not pass the check, the authorization request is rejected.

The checking, by the certificate issuance module, of correctness of the authorization request includes checking whether a format and content of the authorization request are correct.

In step 404, the certificate issuance module obtains the following information: device information of the WeChat client, a validity period, a valid-from date, and a valid-to date of the digital certificate, a unique number of the digital certificate, and a public key of the WeChat client.

In step 405, the certificate issuance module signs the obtained information by using a private key of the WeChat platform, to obtain a signature file, such as the digital certificate.

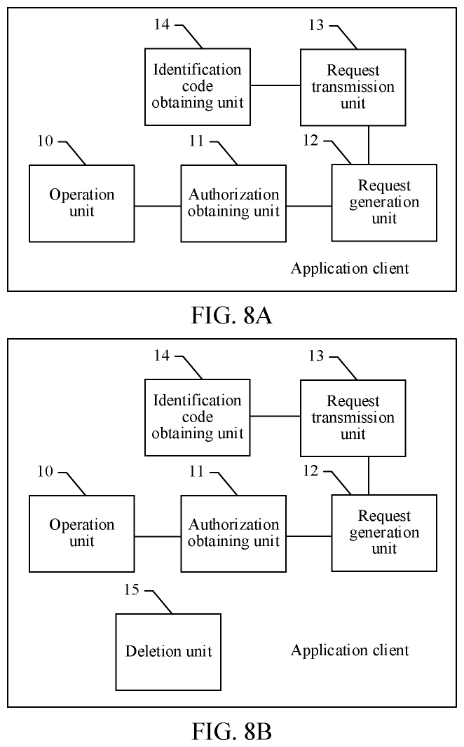

An embodiment of this application further provides an application client of which a schematic structural diagram is shown in FIG. 8A. The application client may specifically include: an operation unit 10, an authorization obtaining unit 11, a request generation unit 12, a request transmission unit 13, and an identification code obtaining unit 14. One or more units of the application client can be implemented by processing circuitry.

The operation unit 10 is configured to receive operation information of pulling an identification code. The authorization obtaining unit 11 is configured to obtain a device authorization message of the application client according to the operation information received by the operation unit 10. The request generation unit 12 is configured to generate a pull request for the identification code, the pull request including a user identifier, device information, and the device authorization message of the application client obtained by the authorization obtaining unit 11. The request transmission unit 13 is configured to transmit the pull request, generated by the request generation unit 12, to an application platform, so that after the user identifier, the device information, and the device authorization message are verified by the application platform, the application platform returns information about a corresponding identification code to the application client. Further, the identification code obtaining unit 14 is configured to receive the information about the identification code, the information being transmitted by the application platform according to the pull request transmitted by the request transmission unit 13.

Further, the authorization obtaining unit 11 in the application client is specifically configured to determine whether a storage of the application client includes the device authorization message. If yes, the device authorization message is extracted from the storage of the application client. If not, the device authorization message can be obtained in the following two manners:

(1) The authorization obtaining unit 11 is specifically configured to transmit an authorization request for the device authorization message to the application platform if the storage of the application client does not include the device authorization message, the authorization request including the device information of the application client; receive a verification command returned, according to the authorization request, by the application platform, and display a verification information input interface, the input interface including a verification information input box; transmit, when receiving, through the input box, verification information inputted by the user, the inputted verification information to the application platform for verification; and if the verification information inputted by the user is verified by the application platform, receive the device authorization message returned, according to the device information, by the application platform.

(2) The authorization obtaining unit 11 is alternatively configured to display a verification information input interface, the input interface including a verification information input box if the storage of the application client does not include the device authorization message; transmit, when receiving, through the input box, verification information inputted by a user, an authorization request for the device authorization message to the application platform, the authorization request including the device information of the application client and the verification information inputted by the user; and if the verification information inputted by the user is verified by the application platform, receive the device authorization message returned, according to the device information, by the application platform.

In an embodiment of this application, as shown in FIG. 8B, the application client may further include a deletion unit 15, configured to receive a device authorization message deletion command transmitted by the application platform, and delete the device authorization message stored in the application client.

In the application client according to the embodiment, the authorization obtaining unit 11 may obtain the device authorization message of an application client according to the operation information of pulling the identification code initiated by the user, the request generation unit 12 adds the device authorization message, the device information, and the user identifier of the application client to the pull request, and the request transmission unit 13 transmits the pull request to the application platform. The application platform returns the information about a corresponding identification code to the application client only after the device authorization message, the device information, and the user identifier in the pull request are verified by the application platform. Because the device authorization message obtained by the application client requires network authorization, an identity corresponding to the application client may be represented. In this way, information about a corresponding identification code can be obtained only when a pull request for an identification code is initiated by the application client that is authorized with the device authorization message, and the device authorization message, device information, and a user identifier of the application client are verified. Therefore, security of proactively obtaining an identification code by an application client is improved.

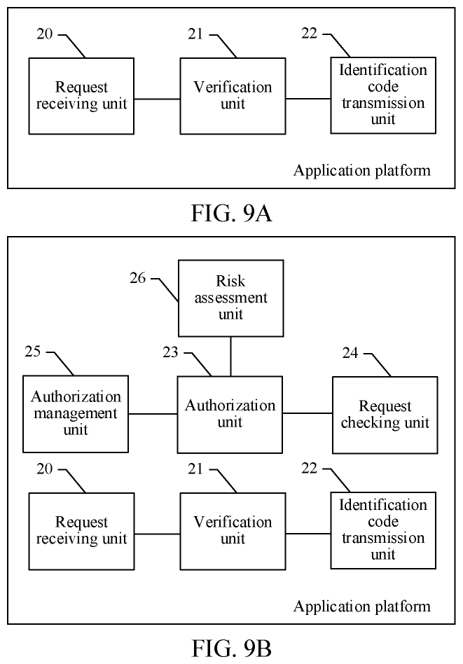

An embodiment of this application further provides an application platform. A schematic structural diagram of the application platform is shown in FIG. 9A. The application platform may specifically include: a request receiving unit 20, a verification unit 21, and an identification code transmission unit 22. One or more units of the application platform can be implemented by processing circuitry.

The request receiving unit 20 is configured to receive a pull request for an identification code transmitted by an application client, the pull request including a device authorization message, device information, and a user identifier of the application client. The verification unit 21 is configured to perform verification on the device authorization message in the pull request received by the request receiving unit 20 in a case that a storage of an application platform includes correspondences between the user identifier, the device information, and the device authorization message in the pull request. The identification code transmission unit 22, is configured to obtain, in a case that the device authorization message in the pull request is verified by the verification unit 21, information about a corresponding identification code according to the pull request, and transmit the information about the identification code to the application client.

In an embodiment of this application, as shown in FIG. 9B, the application platform according to this embodiment may further include: an authorization unit 23, a request checking unit 24, an authorization management unit 25, and a risk assessment unit 26.

The authorization unit 23 is specifically configured to receive an authorization request for the device authorization message transmitted by the application client; transmit, if the authorization request includes the device information and user information of the application client, a verification command to the application client; receive verification information that is inputted by a user and that is transmitted, according to the verification command, by the application client, and perform verification on the verification information inputted by the user; generate a device authorization message according to the device information, and transmit the generated device authorization message to the application client if the verification information inputted by the user is verified; and store correspondences between the user identifier, a device authorization message, and device information.

The authorization unit 23 is further configured to perform, if the authorization request includes the verification information inputted by the user, and the user identifier and the device information of the application client, verification on the verification information inputted by the user; generate a device authorization message according to the device information, and transmit the generated device authorization message to the application client if the verification information inputted by the user is verified; and store correspondences between the user identifier, the device authorization message, and the device information.

The request checking unit 24 is configured to check correctness of the authorization request received by the authorization unit 23, and if the authorization request passes the correctness check, inform the authorization unit 23 to perform the step of generating the device authorization message.

The authorization management unit 25 is configured to set, before the authorization unit 23 stores correspondences between the user identifier, the device authorization message, and the device information, if the storage of the application platform includes an existing device authorization message corresponding to the user identifier, the existing device authorization message into an invalid state, or delete the existing device authorization message.

The risk assessment unit 26 is configured to determine a risk assessment score corresponding to the user identifier of the application client according to a preset period, and transmit, in a case that the risk assessment score is greater than a specific preset value, a device authorization message deletion command to the application client, to delete the device authorization message stored in the application client and authorized by the authorization unit 23.

In view of the above, in this embodiment, the pull request for the identification code that is transmitted from the application client to the application platform includes the device authorization message, the device information, and the user identifier of the application client. Therefore if the storage of the application platform includes correspondences between the device authorization message, the device information, and the user identifier, the verification unit 21 in the application platform performs verification on the device authorization message in the pull request. Only if the verification succeeds, the identification code transmission unit 22 returns the corresponding information about the identification code to the application client. Because the device authorization message obtained by the application client requires network authorization, an identity corresponding to the application client may be represented. In this way, information about a corresponding identification code can be obtained only when a pull request for an identification code is initiated by the application client that is authorized with the device authorization message, and the device authorization message, device information, and a user identifier of the application client are verified. Therefore, security of proactively obtaining an identification code by an application client is improved.

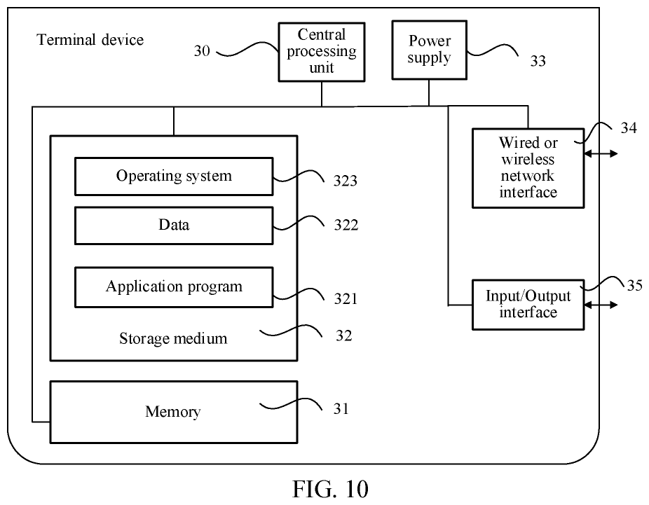

An embodiment of this application further provides a terminal device. A schematic structural diagram of the terminal device is shown in FIG. 10. The terminal device may vary greatly due to different configurations or performance, and may include one or more central processing units (CPU) 30, such as processing circuitry that includes one or more processors, a memory 31, and one or more storage mediums 32 such as one or more mass storage devices that store application programs 321 or data 322. The memory 31 and the storage medium 32 may be transient storage such as volatile storage or permanent storage such as non-volatile storage. The program stored in the storage medium 32, such as a non-transitory computer-readable storage medium, may include one or more modules (not shown), and each module may include a series of instructions and operations for the terminal device. Further, the CPU 30 may be configured to communicate with the storage medium 32, and perform, on the terminal device, the series of instructions and operations in the storage medium 32.

Specifically, the application programs 321 stored in the storage medium 32 include an identification code pulling application program. The application program includes the operation unit 10, authorization obtaining unit 11, request generation unit 12, request transmission unit 13, identification code obtaining unit 14, and deletion unit 15 in the foregoing application client. Repeated parts herein are not described again. Further, the CPU 30 may be configured to communicate with the storage medium 32, and perform, on the terminal device, a series of operations corresponding to the identification code pulling application program stored in the storage medium 32.

The terminal device may further include one or more power supplies 33, one or more wired or wireless network interfaces 34, one or more input/output interfaces 35, and/or one or more operating systems 323, for example, Windows Server™, Mac OS X™, Unix™, Linux™, or FreeBSD™.

The steps performed by the application client in the foregoing method embodiment may be based on the structure of the terminal device shown in FIG. 10.

An embodiment of this application further provides a server. A structure of the server may be similar to the structure of the terminal device shown in FIG. 10. Differences in the server of this embodiment can include, an application program stored in a storage medium includes an identification code pulling application program, including the request receiving unit 20, the verification unit 21, the identification code transmission unit 22, the authorization unit 23, the request checking unit 24, the authorization management unit 25, and the risk assessment unit 26 in the foregoing application platform, and details are not described herein again. Further, a CPU may be configured to communicate with the storage medium, and perform, on the server, a series of operations corresponding to the identification code pulling application program stored in the storage medium.

An embodiment of this application further provides a storage medium (e.g., a non-transitory computer-readable storage medium), storing a plurality of instructions, the instructions being suitable to be loaded by a processor to perform the identification code pulling method performed by the foregoing application platform or the application client.

An embodiment of this application further provides a terminal device, including a processor and a storage medium, the processor being configured to implement each instruction. The storage medium is configured to store a plurality of instructions, the instructions being loaded by the processor to perform the identification code pulling method performed by the foregoing application client.

An embodiment of this application provides a server, including a processor and a storage medium, the processor being configured to implement each instruction. The storage medium is configured to store a plurality of instructions, the instructions being loaded by the processor to perform the identification code pulling method performed by the foregoing application platform.

Optionally, in this embodiment, a person of ordinary skill in the art may understand that all or some of the steps of the methods in the foregoing embodiments may be implemented by a program by instructing relevant hardware. The program may be stored in a computer-readable storage medium, and the storage medium may include: a read-only memory (ROM), a random access memory (RAM), a magnetic disk, a compact disc, or the like.

The identification code pulling method, the storage medium, the terminal device, and the server provided in the embodiments of this application are described in detail above. The principle and implementations of this application are described herein by using specific examples. The descriptions of the foregoing embodiments are merely used for helping understand the method and ideas of this application. In addition, a person skilled in the art can make variations to this application in terms of the specific implementations and application scopes according to the ideas of this application. Therefore, the content of this specification shall not be construed as a limit on this application.

What is claimed is:

1. An identification code pulling method, the method comprising:
receiving, by processing circuitry, a user input corresponding to a request for an identification code;
obtaining, by the processing circuitry, a device authorization message of an application client based on the user input corresponding to the request for the identification code;
generating, by the processing circuitry, a pull request for the identification code, the pull request including a user identifier, device information, and the device authorization message of the application client;
transmitting the pull request to an application platform; and
receiving, by the processing circuitry, identification code information corresponding to the identification code from the application platform when the user identifier, the device information, and the device authorization message are verified by the application platform.

2. The method according to claim 1, wherein the obtaining the device authorization message comprises:
extracting the device authorization message from a memory of a terminal device that runs the application client when the device authorization message is stored in the memory.

3. The method according to claim 2, wherein the obtaining the device authorization message further comprises:
transmitting an authorization request for the device authorization message to the application platform when the device authorization message is not stored in the memory, the authorization request including the device information of the application client;
receiving a verification command returned, according to the authorization request, by the application platform;
displaying a verification information input interface that includes a verification information input box;
transmitting verification information to the application platform for verification when the verification information is input into the verification information input box; and
receiving the device authorization message returned, according to the device information, by the application platform, when the verification information input by a user is verified by the application platform.

4. The method according to claim 2, wherein the obtaining the device authorization message further comprises:
displaying a verification information input interface that includes a verification information input box when the device authorization message is not stored in the memory;
transmitting an authorization request for the device authorization message to the application platform when verification information is input into the verification information input box, the authorization request including the device information of the application client and the verification information input by a user; and
receiving the device authorization message returned, according to the device information, by the application platform when the verification information input by the user is verified by the application platform.

5. The method according to claim 1, further comprising:
receiving a device authorization message deletion command from the application platform; and
deleting the device authorization message stored in the application client in response to the received device authorization message deletion command.

6. An identification code pulling method, the method comprising:
receiving, by processing circuitry, a pull request for an identification code from an application client, the pull request including a device authorization message, a user identifier, and device information of the application client;
performing, by the processing circuitry, verification on the device authorization message in the pull request when correspondences between the device authorization message, the device information, and the user identifier are stored in a memory;
obtaining, by the processing circuitry, identification code information corresponding to the identification code according to the pull request when the device authorization message in the pull request is verified; and
transmitting, by the processing circuitry, the identification code information to the application client.

7. The method according to claim 6, before the receiving the pull request for the identification code, the method further comprises:
receiving an authorization request for the device authorization message from the application client;
transmitting a verification command to the application client when the authorization request includes the user identifier and the device information of the application client;
receiving verification information that is input by a user and that is transmitted, according to the verification command, by the application client;
performing verification on the verification information input by the user;
generating a device authorization message according to the device information when the verification information input by the user is verified;
transmitting the generated device authorization message to the application client; and
storing correspondences between the user identifier, the device authorization message, and the device information.

8. The method according to claim 7, wherein before the storing the correspondences, the method further comprises:
setting existing device authorization message into an invalid state, or deleting the existing device authorization message.

9. The method according to claim 6, wherein the device authorization message is a digital certificate, and the performing the verification on the device authorization message comprises:
obtaining, according to a private key, certificate information from the digital certificate, the certificate information including device information, a certificate number, and a validity period of the certificate;
performing verification separately on the device information, the certificate number, and the validity period of the certificate;
verifying the device authorization message in the pull request when the certificate information is verified; and
determining that the device authorization message in the pull request fails to be verified when at least one of the device information, the certificate number, and the validity period of the certificate fails to be verified.

10. The method according to claim 6, further comprising:
determining a risk assessment score corresponding to the user identifier of the application client according to a preset period; and
transmitting a device authorization message deletion command to the application client when the risk assessment score is greater than a preset value, to delete the device authorization message stored in the application client.

11. A terminal device, comprising:
processing circuitry configured to
receive a user input corresponding to a request for an identification code,
obtain a device authorization message of an application client run by the processing circuitry based on the user input corresponding to the request for the identification code,
generate a pull request for the identification code, the pull request including a user identifier, device information, and the device authorization message of the application client,
transmit the pull request to an application platform, and
receive identification code information corresponding to the identification code from the application platform when the user identifier, the device information, and the device authorization message are verified by the application platform.

12. The terminal device according to claim 11, wherein the processing circuitry is configured to:
extract the device authorization message from a memory of the terminal device when the device authorization message is stored in the memory.

13. The terminal device according to claim 12, wherein the processing circuitry is configured to:
transmit an authorization request for the device authorization message to the application platform when the device authorization message is not stored in the memory, the authorization request including the device information of the application client;
receive a verification command returned, according to the authorization request, by the application platform;
display a verification information input interface that includes a verification information input box;
transmit verification information to the application platform for verification when the verification information is input into the verification information input box; and
receive the device authorization message returned, according to the device information, by the application platform, when the verification information input by a user is verified by the application platform.

14. The terminal device according to claim 12, wherein the processing circuitry is configured to:
display a verification information input interface that includes a verification information input box when the device authorization message is not stored in the memory;
transmit an authorization request for the device authorization message to the application platform when verification information is input into the verification information input box, the authorization request including the device information of the application client and the verification information input by a user; and
receive the device authorization message returned, according to the device information, by the application platform when the verification information input by the user is verified by the application platform.

15. A server, comprising:
processing circuitry configured to
receive a pull request for an identification code from an application client, the pull request including a device authorization message, a user identifier, and device information of the application client,
perform verification on the device authorization message in the pull request when correspondences between the device authorization message, the device information, and the user identifier are stored in a memory,
obtain identification code information corresponding to the identification code according to the pull request when the device authorization message in the pull request is verified, and
transmit the identification code information to the application client.

16. The server according to claim 15, before the pull request for the identification code is received, the processing circuitry is configured to:
receive an authorization request for the device authorization message from the application client;
transmit a verification command to the application client when the authorization request includes the user identifier and the device information of the application client;
receive verification information that is input by a user and that is transmitted, according to the verification command, by the application client;
perform verification on the verification information input by the user;
generate a device authorization message according to the device information when the verification information input by the user is verified;
transmit the generated device authorization message to the application client; and
store correspondences between the user identifier, the device authorization message, and the device information.

17. The server according to claim 16, wherein before the correspondences are stored, the processing circuitry is configured to:
set existing device authorization message into an invalid state, or delete the existing device authorization message.

18. The server according to claim 15, wherein the device authorization message is a digital certificate, and the processing circuitry is configured to:
obtain, according to a private key, certificate information from the digital certificate, the certificate information including device information, a certificate number, and a validity period of the certificate;
perform verification separately on the device information, the certificate number, and the validity period of the certificate;
verify the device authorization message in the pull request when the certificate information is verified; and
determine that the device authorization message in the pull request fails to be verified when at least one of the device information, the certificate number, and the validity period of the certificate fails to be verified.

19. A non-transitory computer-readable storage medium storing instructions which when executed by a processor cause the processor to perform the identification code pulling method according to claim 1.

20. A non-transitory computer-readable storage medium storing instructions which when executed by a processor cause the processor to perform the identification code pulling method according to claim 6.
